(19) United States
(12) Patent Application Publication
(10) Pub. No.: US 2026/0077345 A1
(43) Pub. Date: Mar. 19, 2026

(54) MICROSCOPY VACUUM CELL APPARATUS FOR AIR SENSTIVE SAMPLES AND METHOD OF TRANSPORT

(71) Applicant: Quantum Design International, Inc., San Diego, CA (US)

(72) Inventors: Stefano Spagna, San Diego, CA (US); Cesar Chialvo, San Diego, CA (US)

(21) Appl. No.: 19/333,178

(22) Filed: Sep. 18, 2025

Related U.S. Application Data
(60) Provisional application No. 63/696,607, filed on Sep. 19, 2024.

(51) Int. Cl. B01L 3/00

(52) U.S. Cl. CPC B01L 3/50; B01L 2200/025; B01L 2200/18; B01L 2300/042; B01L 2300/14

(57) ABSTRACT

A vacuum cell configured to transport a specimen for imaging by an imaging device in prescribed vacuum conditions includes a first base part including a mounting engagement portion and a sample support portion coupled to the mounting engagement portion. The mounting engagement portion is configured to be engageable with the imaging device, and the sample support portion is configured to support the specimen for imaging. A second upper part is operatively connectable to the first base part and is selectively transitional relative to the first base part between an open position and a closed position. The second upper part and the first base part collectively define a sample chamber configured to retain the sample when the second upper part is in the closed position. The sample chamber is exposed to an outside environment when the second upper part is in the open position.

### CROSS-REFERENCE TO RELATED APPLICATIONS

This application claims the benefit of U.S. Provisional Application Ser. No. 63/696,607 filed Sep. 19, 2024, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to sample imaging and analysis, and more specifically, to a device and related methodology for mounting and transporting air sensitive samples from an environmentally controlled facility to a low to high vacuum chamber of a microscope, such as an optical, scanning electron or atomic force microscope.

### 2. Description of the Related Art

There are many materials that are the subject of leading fundamental and applied scientific research that are highly reactive to oxygen and water. As such, microscopy characterization of these materials is challenging, because these materials are manufactured and stored in a highly controlled environment facilities such as a glove box. To date, several approaches have been developed to address this challenge.

In a first approach, certain inert gas environmentally compatible microscopes have been created to be placed and operated inside a glove box such as the Cypher ES Atomic Force Microscope (AFM) or a broad class of desktop Scanning Electron Microscopes (SEM). However, AFM and SEM use in a glovebox can be inconvenient as the microscopes occupy valuable space inside the limited manufacturing and storage space provided by these facilities. Furthermore, most AFM and SEM require extensive isolation to reduce imaging noise caused by ambient acoustic and vibrational sources. This greatly complicates their integration with gloveboxes where specialized isolation requirements are not typically available, thus degrading the ultimate sensitivity of the imaging technique.

In a second approach, hermetically sealed cells have been designed for use with the environmental microscopes, such as the Cypher ES AFM, to transfer samples under ambient pressure from a glovebox to an AFM operating at ambient pressure and under a constant flow of an inert gas, such as Argon or dry Nitrogen. These cells, however, are not designed to enable the transfer of a sample from the controlled environment of a glove box into a vacuum environment of a High Vacuum AFM or Scanning Electron Microscope (SEM). Moreover, these cells do not offer un-hindered access to the sample surface. As such, the Cypher hermetically sealed sample cell, while preventing the sample from being exposed to the oxidizing ambient environment, is not compatible with vacuum-based microscopes that are needed for characterizing air sensitive samples under the most stringent environmental conditions.

In particular, the ambient hermetically sealed sample cell associated with conventional approaches remains sealed throughout the sample characterization and does not offer: 1) ability to be opened in-situ while mounted in the host microscope from the sealed configuration to offer un-hindered access to the sample surface so that imaging utilizing various microscopy techniques such as SEM can be performed, 2) means to evacuate the cell prior to transporting it into a vacuum microscope, or even when inserted into the host microscope itself which is required in order to avoid contamination of the microscope high vacuum environment, and 3) means for re-sealing the hermetically sample cell inside the high vacuum microscope so that the sample can be transported back to the glove box without exposure to air.

A third approach utilizes load lock mechanisms that are designed to transfer air sensitive samples from a glove box to a high to ultra-high vacuum-based microscope employing imaging based on charged particles such as in an SEM. This approach tends to be overly complex and comprised at a minimum of a sample shuttle, vacuum compatible anti-chamber (the load lock) and means for evacuating it attached to the microscope, precise positioning sample transfer arm capability and specialized sample mounting stages.

This complexity aims at allowing insertion of samples into a microscope without ever venting it to ambient conditions in order to maintain a very high vacuum level within the microscope itself (typical Ultra-High Vacuum (UHV)). These systems can be prohibitively expensive and are practically hard to implement in compact instruments where space requirements are a consideration.

Accordingly, there is a need in the art for a device which allows the sample chamber to be simply vented for the purpose of introducing the vacuum cell into the microscope, and then evacuating the microscope sample chamber containing the vacuum cell. Various aspects of the present disclosure address this particular need, as will be discussed in more detail below.

### BRIEF SUMMARY

In accordance with one embodiment of the present disclosure, there is provided a device which allows the sample chamber to be simply vented for the purpose of introducing the vacuum cell into the microscope, and then evacuating the microscope sample chamber containing the vacuum cell. This workflow is markedly different from workflows using conventional load-locks where the sample is introduced into an antechamber at ambient conditions and isolated from the main microscope chamber by an isolation valve. The sealed sample shuttle is introduced into the load lock and the latter is evacuated to a low vacuum before the shuttle opens and transports the sample to the microscope itself. Various aspects of the present disclosure aim at reducing this complex workflow and circumventing the need for a load lock and associated ancillary equipment.

According to one embodiment, there is provided a vacuum cell configured to transport a specimen for imaging by an imaging device in prescribed vacuum conditions. The vacuum cell includes a first base part including a mounting engagement portion and a sample support portion coupled to the mounting engagement portion. The mounting engagement portion is configured to be engageable with the imaging device, and the sample support portion is configured to support the specimen for imaging. A second upper part is operatively connectable to the first base part and is selectively transitional relative to the first base part between an open position and a closed position. The second upper part and the first base part collectively define a sample chamber configured to retain the sample when the second upper part is in the closed position. The sample chamber is exposed to an outside environment when the second upper part is in the open position.

The second upper part may include a pressure control opening formed therein. The pressure control opening may extend between the sample chamber and an ambient environment outside the vacuum cell. The vacuum cell may also include a flexible membrane extending over the pressure control opening at an outer surface of the second upper part.

The second upper part may include a chamber peripheral surface and an end surface coupled to the chamber peripheral surface. The chamber peripheral surface may be configured to extend upwardly relative to the sample support portion of the first base part when the second upper part is in the closed position.

The first base part may be connected to the second upper part via a spring configured to bias the second upper part toward the open position. The first base part may include a first outer surface and a first groove formed in the first outer surface and the second upper part includes a second outer surface and a second groove formed in the second outer surface. The spring may have a first connector part receivable in the first groove and a second connector part receivable in the second groove to facilitate connection with the first base part and second upper part.

The first base part may be pivotally connected to the second upper part such that the second upper part transitions between the open position and the closed position via pivotal movement of the second upper part relative to the first base part.

The mount engagement portion may include a pin stub adapted for engagement with the imaging device.

The vacuum cell may include an o-ring configured to create a fluid-tight seal between the first base part and second upper part when the second upper part is in the closed position. At least one of the first base part and the second upper part may include a recess adapted to receive the o-ring.

According to another embodiment, there is provided a vacuum cell configured to transport a specimen in an enclosure and enable opening of the vacuum cell in-situ for imaging by an imaging device in prescribed vacuum conditions. The vacuum cell includes a first base part including a mounting pin adapted to be received in an opening formed in the imaging device. The first base part also includes a sample support surface coupled to the mounting pin, with the sample support surface being configured to support the specimen for imaging. The vacuum cell also includes a second upper part operatively connectable to the first base part and having a recess formed therein. The second upper part is selectively transitional relative to the first base part between an open position and a closed position, with the recess of the second upper part being moved over the sample support surface when the second upper part is in the closed position such that the second upper part and first base part collectively defining a sample chamber configured to retain the sample. The sample chamber is exposed to an outside environment when the second upper part is in the open position.

There is also provided a method of imaging a sample, with the method comprising the steps of mounting the sample on a mounting surface of a first base part of a vacuum cell; enclosing the sample within a sample chamber defined by the first base part and a second upper part of the vacuum cell; creating a pressure differential between the sample chamber and an ambient environment outside the vacuum cell; and opening the vacuum cell when the vacuum cell is aligned with an imaging device to facilitate imaging of the sample.

The enclosing step may include pivoting the second upper part relative to the first base part, with the second upper part being connected to the first base part via a hinge to facilitate pivotal movement between the second upper part and the first base part.

The enclosing step may include placing the second upper part over the first base part.

The method may further comprise the step of attaching a spring to the first base part and the second upper part, with the spring being configured to impart a force on the second upper part to urge the second upper part away from the first base part when the second upper part is closed over the first base part. The step of attaching the spring may include inserting a first connector part of the spring in a first groove formed on the first base part, and inserting a second connector part of the spring in a second groove formed on the second upper part.

The opening step may include creating a pressure differential where pressure outside of the vacuum cell is less than pressure inside sample chamber.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a first embodiment of a vacuum cell according to an embodiment of the present disclosure;

FIG. 2 is a cross-sectional view of the vacuum cell of FIG. 1;

FIG. 3 is an exploded, perspective view of the vacuum cell of FIG. 1;

FIG. 4 is a side cross-sectional view of a second embodiment of a vacuum cell;

FIG. 5 is an upper perspective view of the vacuum cell of FIG. 4;

FIG. 6 is an exploded view of the vacuum cell of FIG. 4;

FIG. 7 is a is an upper perspective view of a vacuum cell pumping station;

FIG. 8 is an upper perspective view of a vacuum cell ready for being enclosed within the pumping station;

FIG. 9 is an upper perspective view of the actuation of the pumping station with the vacuum cell loaded therein; and

FIGS. 10A-F depict a series of photographs showing mechanical opening of the vacuum cell using a pin and lever.

Common reference numerals are used throughout the drawings and the detailed description to indicate the same elements.

### DETAILED DESCRIPTION

The detailed description set forth below in connection with the appended drawings is intended as a description of certain embodiments of a vacuum cell for holding a sample for scientific imaging and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to a vacuum cell utilized for the purpose of mounting and transporting air sensitive samples from an environmentally controlled storage facility to a microscope operating under vacuum conditions, such as is the case of a scanning electron microscope. The vacuum cell may generally include a base upon which the sample is mounted and a vacuum shroud configured to protect the sample from oxidation that could result from exposure to ambient air and moisture. The vacuum cell may be configured to facilitate selective control of pressure conditions therein to either a low vacuum or high vacuum.

The hardware and related method of use described herein may enable samples to be mounted in the vacuum cell while they are within a glove box or other controlled inert gas environmental facility, where samples or devices are routinely manufactured, physically or chemically treated and stored. While in the glove box, the vacuum cell can then be simply evacuated using a pumping station and fixture, sealed hermetically and, be ready to be taken out of the glove box. The hermetically sealed vacuum cell is then removed from the glove box, transported, and installed into a sample chamber of a microscope that has been vented to atmospheric conditions. The microscope sample chamber containing the hermetically sealed cell is then evacuated to a high vacuum to allow, for example, imaging techniques employing charged particles such as electrons to be used as would be the case in a Scanning Electron Microscope (SEM). A key aspect of the present disclosure is the fact that the cell can be opened in-situ in the host microscope once high vacuum conditions are attained in the microscope sample chamber. Opening the vacuum cell from the hermetically sealed configuration may offer un-hindered access to the sample surface for the purpose of applying a wide range of microscopic probes including Atomic Force Microscopy, Scanning Electron Microscopy and Energy Dispersive X-ray Analysis (EDS) techniques either separately or concurrently. Furthermore, the vacuum cell may be re-sealed under high vacuum conditions, in-situ in the microscope sample chamber. This critical feature enables the user, at the end of an experiment, to vent the microscope sample chamber for the purpose of removing the vacuum cell while maintaining the sample within the hermetically sealed cell under vacuum conditions. Using these teachings the sample may be transported back into the glovebox without exposure to air for storage, further manipulation, and analysis without the risk of chemical degradation.

The device described herein may be particularly important to researchers studying a wide range of scientifically interesting materials such as single-layer chromium trihalides (CrX_{y}., where X═I, Br, and Cl) which exhibit novel physical properties relevant to technological applications such as spintronic devices. Many of these materials, however, suffer from a significant level of chemistry degradation caused by exposure to ambient conditions which render device fabrication and sample analysis in its pristine state (i.e., free of oxides or water contamination) extremely challenging. The device and related methodology disclosed herein describes a miniature vacuum cell that may facilitate the transport of air sensitive samples, such as single chromium trihalides, or devices from an environmentally controlled manufacturing or storage facility where the concentration of water and oxygen is kept extremely low, into a microscope without subjecting the sample to detrimental ambient conditions.

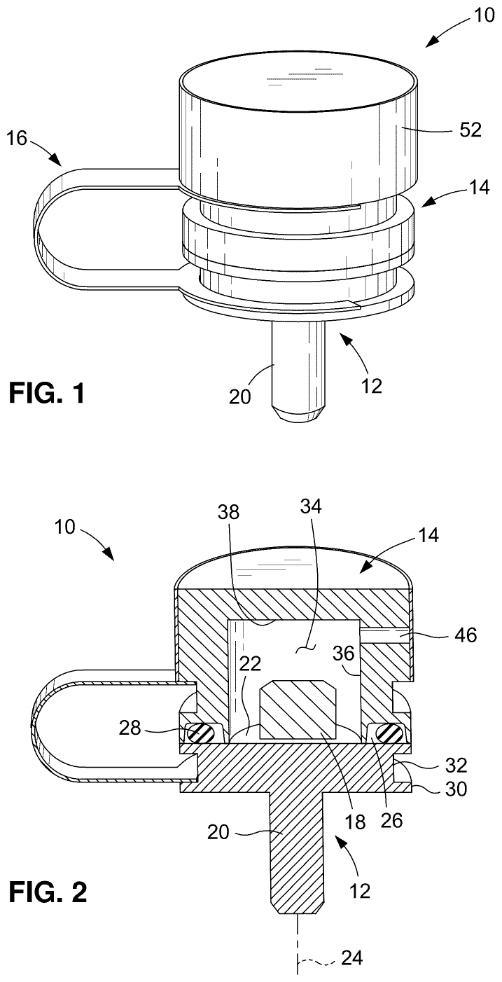

Referring now to FIG. 1, there is depicted one embodiment of a vacuum cell 10 configured to enable imaging of pristine (i.e., un-oxidized) samples. The vacuum cell 10 generally includes a first base part 12, a second upper part 14, and a spring 16 connecting the first base part 12 and second upper part 14. In more detail, the first base part 12 is configured to support the air sensitive sample 18 and includes a mount engagement portion 20 and a sample support portion 22. In the exemplary embodiment, the mount engagement portion 20 may include a pin stub capable of being received within a corresponding bore or recess formed in an imaging device. For instance, the pin stub 20 may be a standard 12 mm pin stub that is commonly used with Scanning Electron Microscopes. The mount engagement portion 20 may enable the vacuum cell 10 to be installed in the vacuum sample chamber of a microscope at a suitable working distance allowing imaging of the sample 18 when the vacuum cell 10 is opened in situ. For instance, the vacuum cell 10 with its standard pin stub interface may allow the vacuum cell 10 to be easily installed at the proper working distance for imaging below the pole pieces of a Scanning Electron Microscope.

The sample support portion 22 may include a generally flat, planar surface upon which the sample 18 may be mounted. The surface 22 may be generally perpendicular to an axis 24 defined by the mount engagement portion 20. The first base part 12 may include electrodes that can be used to make electrical contact to the sample 18 for the purpose of biasing the sample 18 to a reference voltage. For instance, the electrodes/electrical contacts may be located on the pin stub 20, and may be disposed in electrical communication with corresponding contacts on the imaging device when the first base part 12 is mounted on the imaging device. The electrical contacts may be in electrical communication with the sample support surface 22 to facilitate application of a voltage to the sample 18. The application of the voltage may be controlled via a current source integrated into the imaging device,

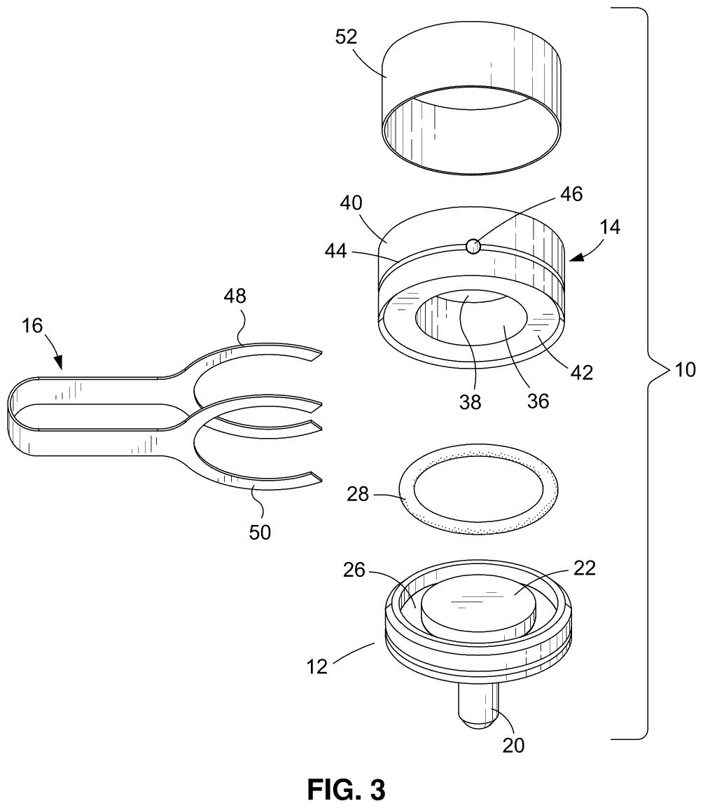

The first base part 12 may additionally be configured to interface with a sealing body to facilitate a fluid tight seal between the first base part 12 and the second upper part 14. In the exemplary embodiment, depicted in FIG. 3, the first base part 12 includes a generally flat, smooth annular surface 26 recessed below the sample support surface 22 and circumnavigating the sample support surface 22. The annular surface 26 may be configured to receive an O-ring 28 which assists in creating a fluid tight seal between the first base part 12 and the second upper part 14 when the vacuum cell 10 is closed. It is understood that while the exemplary embodiment depicted in FIG. 3 includes the annular surface 26 as being formed on the first base part 12, it is contemplated that the annular surface 26 may be formed on the second upper part 14 without departing from the spirit and scope of the present disclosure. The vacuum cell 10 of FIG. 2 is an example of the annular surface 26 being formed on the second upper part 14.

The first base part 12 may include an outer peripheral surface 30 having a circumferential groove 32 that may entirely circumnavigate the outer peripheral surface 30, or alternatively, partially circumnavigate the outer peripheral surface 30. The groove 32 is configured to facilitate connection between the first base part 12 and the spring 16, as will be described in more detail below.

The second upper part 14 (e.g., a vacuum shroud) may be configured to interface with the first base part 12 to collectively define a sample chamber 34 when the vacuum cell 10 is closed. In particular, the second upper part 14 includes a chamber peripheral surface 36 and a chamber end surface 38, which partially define the sample chamber 34, along with the sample support surface 22. The second upper part 14 further includes an outer peripheral surface 40, and an annular sealing surface 42 extending between the chamber peripheral surface 36 and the outer peripheral surface 40. The outer peripheral surface 40 may protrude slightly beyond the annular sealing surface to define a lip or beveled surface, which may interface with a corresponding beveled surface on the first base part 12 when the vacuum cell is closed. The second upper part 14 may additionally include a circumferential groove 44 that may entirely circumnavigate the outer peripheral surface 40, or alternatively, partially circumnavigate the outer peripheral surface 44. The groove 44 is configured to facilitate connection between the second upper part 14 and the spring 16, as will be described in more detail below. The second upper part 14 may further include a pressure control evacuation inlet 46 extending between the outer peripheral surface 40 and the chamber peripheral surface 36. The pressure control vent 46 may be in fluid communication with the sample chamber 34 to facilitate forming a vacuum in the sample chamber 34, as will also be described in more detail below.

The first base part 12 and/or the second upper part 14 may be made of glass or other “optically transparent” material making it possible to inspect the sample 18 while the sample is sealed from the external environment within the vacuum cell 10.

The first base part 12 and second upper part 14 may be connected via the spring 16, which includes a first part connector 48 and a second part connector 50. The first part connector 48 includes a C-shaped body configured to engage with the groove 32 on the first base part 12, while the second part connector 50 includes a similarly configured C-shaped body configured to engage with the groove 44 on the second upper part 14. The spring 16 is configured to bias the second upper part 14 away from the first base part 12. For instance, the spring 16 may be configured to force the vacuum cell 10 open when the pressure in the microscope chamber is lower than the vacuum in the sample chamber 34. It is understood that the C-shaped body might be manufactured out of a springy materials such as copper-beryllium or steel such that items 16 and 48 are essentially one body.

The vacuum cell 10 may be considered to be in an open position when the sample chamber 34 is exposed. The vacuum cell 10 may be in the open position when loading the sample 18, as well as when imaging the sample 18. The vacuum cell 10 may be considered to be in a closed position when the second upper part 14 is sealed to the first base part 12 via the O-ring 28. That is, the second upper part 14 is urged toward the first base part 12, such that the O-ring 28 is compressed between the first base part 12 and second upper part 14 to create the fluid tight seal between the first base part 12 and second upper part 14.

The vacuum cell 10 additionally includes a flexible membrane 52 positionable around the second upper part 14 to cover the pressure inlet 46. The flexible membrane 52 may be formed from rubber or other materials that are flexible to selectively uncover the inlet 46 for controlling pressure within the chamber 34, yet capable of extending over the pressure control inlet 52 when the desired pressure characteristics within the chamber 34 are achieved to create a fluid tight seal over the pressure control vent 52 to maintain the desired pressure (e.g., vacuum) conditions.

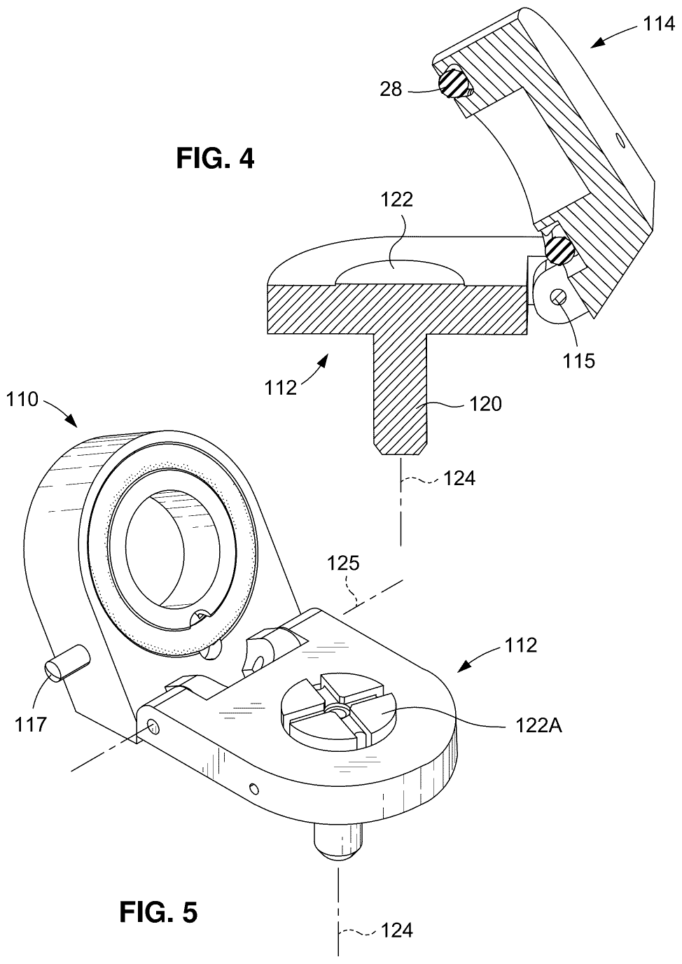

While the foregoing describes the vacuum cell 10 as having the first base part 12 and second upper part 14 connected via a spring 16, and referring now specifically to FIGS. 4-6, it is also contemplated that in other embodiments, a vacuum cell 110 includes a first base part 112 and second upper part 114 connected via a hinge in the form of a pin 115 to facilitate pivotal motion of the second upper part 114 relative to the first base part 12 about an axis defined by the pin 115. The first base part 12 may include a mount engagement portion 122 and a sample support portion 124, similar to that described above.

The second upper part 114 includes a recess to accommodate the O-ring 28 used to create fluid tight seal between the second upper part 114 and the first base part 112 when the vacuum cell 110 is in the closed position. The second upper part 114 may additionally include a handle 117 which may be used to move the second upper part 114 relative to the first base part 12 as the vacuum cell 110 transitions between the open and closed configurations.

In a third embodiment of the vacuum cell, the two halves may include “on-board” (i.e., integrated between the two halves of the vacuum cell e.g., the first base part and the second upper part) hardware to open and close the vacuum cell. Such hardware may include flexures with mechanical advantage to allow opening and closing of the two halves.

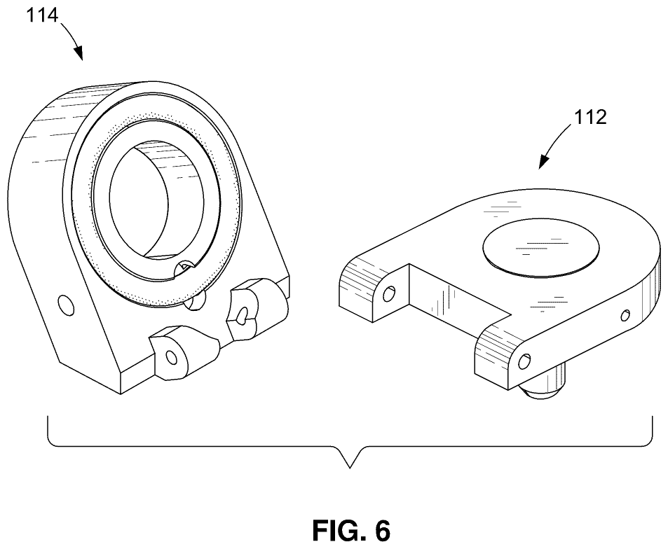

With the basic structure of the vacuum cell 10, 110 having been described above, the following discussion relates to an exemplary use of the vacuum cell 10, 110. The sample(s) 18 may be mounted onto the support surface 22, 122 of the first base part 12, 112, which may entail the use of glue or conductive carbon tape. Typically, a specimen 18 that is to be imaged using SEM microscopy is mounted in such a way that the specimen surface is available for inspection directly below the electron beam. Sticky carbon tape or other tapes and adhesives known in the art may be used to mount the specimen to the first base part 12, 112. If the case of electrical sample biasing, the sample 18 may be electrically connect to electrodes. As noted above, the mounting of sample 18 to the support surface 22, 122 may occur within a glovebox (e.g., a pressure-controlled environment). Furthermore, as depicted in FIG. 5, the support surface 122A may be comprised of a threaded disk that can be screwed and unscrewed into the first base part 112 thus allowing one basic structure to be used interchangeably with many samples glued to the threaded disks. This may be for convenience and ease of use so that samples do not have to be glued and unglued directly to the base part 112, risking its damage and the damage of the sample itself. The removal and insertion of the threaded disk 122A can be achieved with a custom shaped screw driver.

The second upper part 14, 114 is placed over the first base part 12, 112 to close the vacuum cell 10, 110 such that the O-ring 28 is captured between the first base part 12, 112 and the second upper part 14, 114. In the case of the first embodiment of vacuum cell 10, placement of the second upper part 14 over the first base part 12 may include aligning the second upper part 14 with the first base part 12 (e.g., the centers of the first base part 12 and the second upper part 14 are co-axially aligned), and then moving the second upper part 14 toward the first base part 12 until the O-ring 28 is compressed between the first base part 12 and the second upper part 14. The spring 16 may be attached to the parts 12, 14 either before they are connected, or after they are connected. In the case of the second embodiment of vacuum cell 110, placement of the second upper part 114 over the first base part 12 may entail pivoting the second upper part 114 toward the first base part 112 about the axis 125 defined by pin 115. In this regard, the pivot axis 125 may be generally perpendicular to the axis 124 defined by the mount engagement pin 120. The second upper part 114 may be pivoted toward the first base part 112 until the O-ring 28 is compressed between the first base part 112 and the second upper part 114.

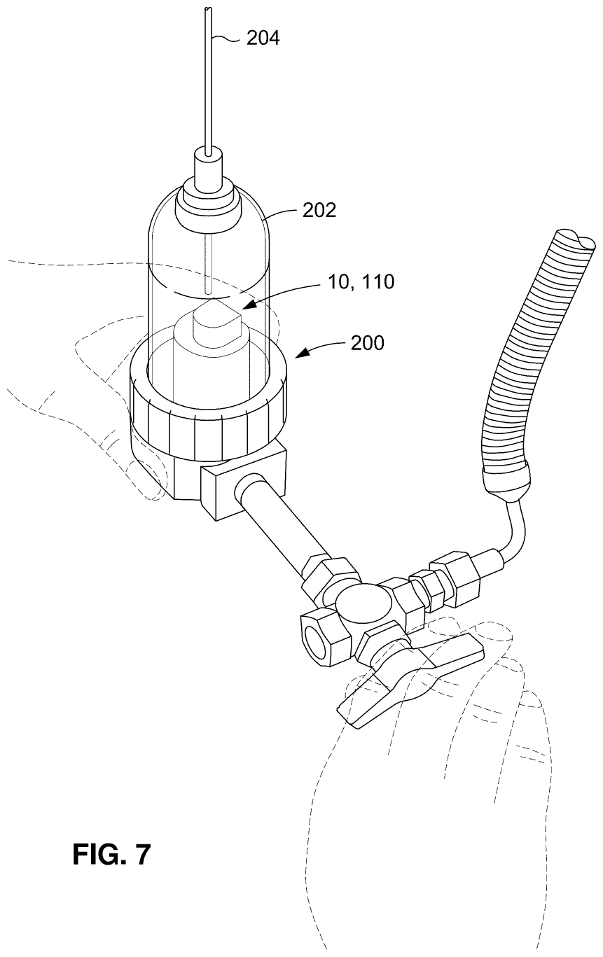

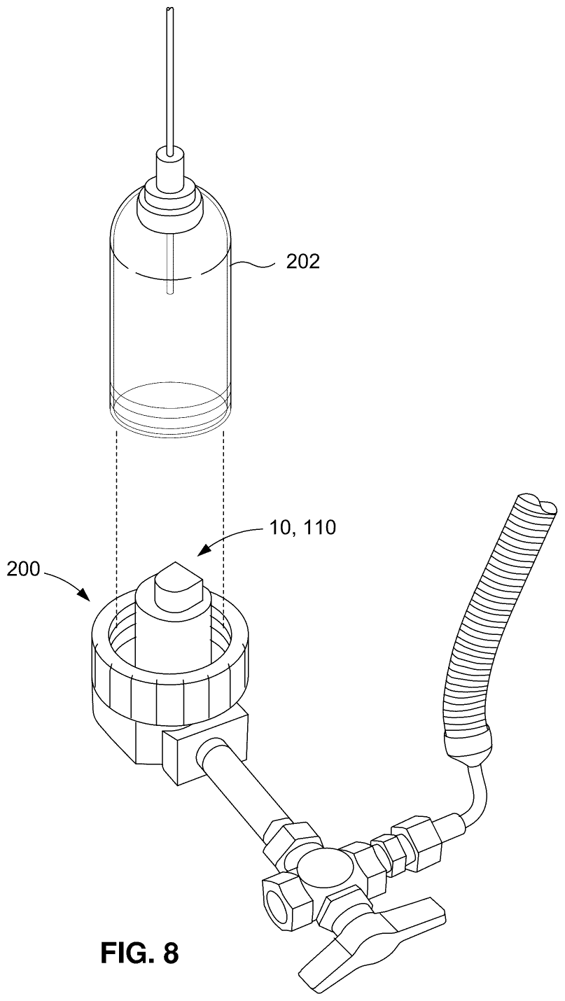

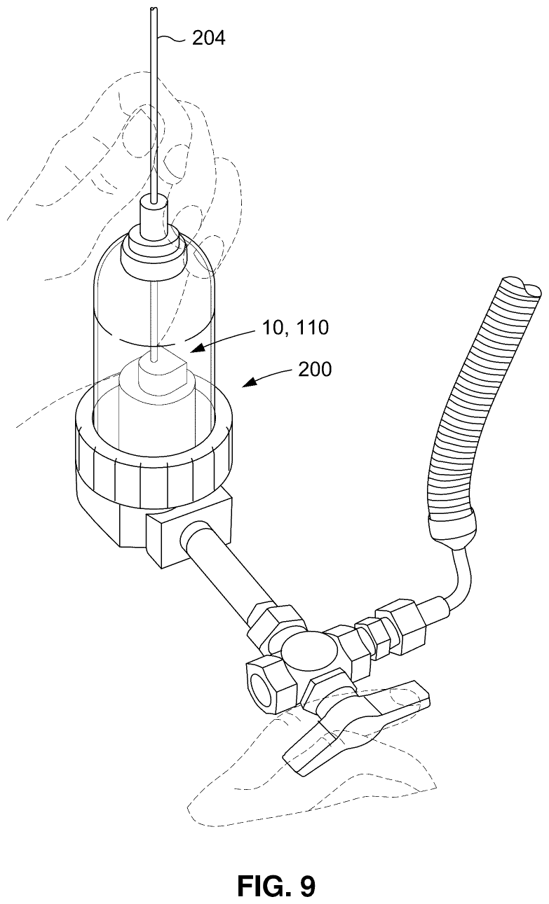

Referring now to FIGS. 7-9, the vacuum cell 10, 110 is inserted onto a pumping fixture 200 to hermetically seal the fixture pumping space with a glass bell jar 202 with integral push rod 204. FIG. 7 shows the vacuum cell 10, 110 already loaded in the pumping fixture 200, while FIG. 8 shows the operator assembling the pumping fixture 200 with the vacuum cell 10, 110 in place prior to placement of the glass bell jar 202 over the vacuum cell 10, 110. As shown in FIG. 9, an operator pumps on the assembly to adjust the pressure to a low vacuum (typically a few milli-Torr) and then the push rod 204 is lowered to close the second upper part 14, 114 of the vacuum cell 10, 110 against a spring that wants to bias the vacuum cell 10, 110 towards the open position. The spring may include the spring 16 connected to the parts 12, 14, or a spring that is outside the vacuum cell 110, but acting on the vacuum cell 110.

The outer environment of the vacuum cell 10, 110 is vented while pressing the vacuum cell 10, 110 shut with the push rod 204 and thus creating a pressure differential that will seal the second upper part 14, 114 on the first base part 12, 112 of the vacuum cell 10, 110. The vacuum cell 10, 110 may then be removed from the pumping fixture 200 and transported from the glove box to the chamber of the microscope that has been previously brought up to atmospheric conditions (i.e., vented). The vacuum sample chamber of the microscope is closed and evacuated by means of its pumping and gas handling systems.

The vacuum cell 10, 110 is opened “in-situ” in the microscope sample chamber once it reaches low to high vacuum as desired for the relevant experimental conditions. In a first embodiment and for a “one-shot” operation the second upper part 14 can be simply opened by means of the spring 16. In this simplest embodiment, once the halves 12, 14 are opened by evacuating the microscope sample chamber to a vacuum higher than the vacuum employed to seal shut the vacuum cell 10, the pressure differential and the spring 16 will force the two halves 12, 14 to separate. This may be suitable in a situation when the experiment is terminated, it is acceptable to no longer maintain the sample 18 under vacuum—i.e., the sample 18 can be allowed to oxidize.

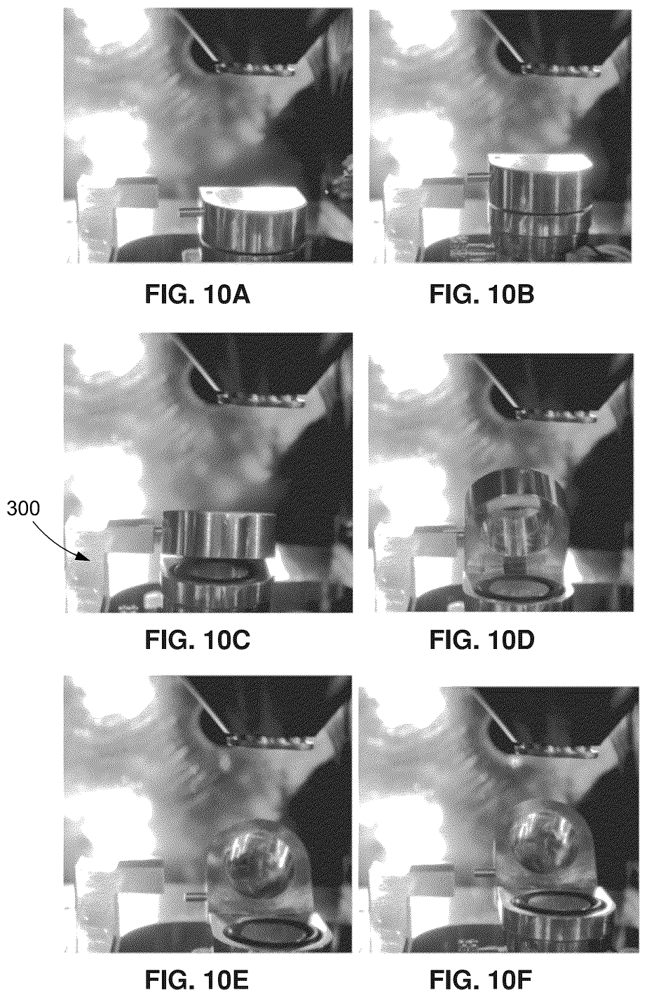

In the case of the second embodiment of the vacuum cell 110, and referring now specifically to FIGS. 10A-F, the microscopist can open the vacuum cell 110 employing the microscope native computer-controlled user interface allowing movement of the sample stage normally used to bring the sample into focus at the right working distance dictated by the microscope (photon, electron or other) optics. By using the sample stage movement (typically 3-axis and tilt are available in most microscopes) and with the aid of a pin and lever 117 present on the first and sample stage (see for an example of a particular embodiment FIG. 14) the vacuum cell 110 can be easily opened by a simple software subroutine. As for example, means for engaging the lever 117, via a fork shaped arm 300 mounted on the microscope stage allows for the upper part 114 to be uncapped from the lower part 112 by simply engaging the lever 117 with the arm 300 and lowering the sample stage below a certain level and moving it forward with respect to the arm 300.

In a third embodiment, opening of the vacuum cell can be accomplished using an integral actuator that is operated through power and electrical signals delivered to the vacuum cell flexure for opening.

Once the imaging and experimentation is concluded the vacuum cell is closed shut while the sample chamber is still under vacuum conditions.

In the case of vacuum cell 110, a microscopist can close the vacuum cell 110 employing the microscope native computer-controlled user interface allowing movement of the sample stage normally used to bring the sample into focus at the right working distance dictated by the microscope (photon, electron or other) optics. By using the sample stage movement (typically 3-axis and tilt are available in most microscopes) and with the aid of a pin and lever means present on the parts 112, 114, the vacuum cell 110 can be easily closed by a simple software subroutine. As for example, means for engaging the lever 117, via a fork shaped arm 300 mounted on the microscope stage allows for the upper part 114 to cap the lower part 112 by simply engaging lever 117 with the fork 300 and moving the stage upwards and then backwards with respect to the arm 300 to allow upper part 114 to close over lower part 112.

It is contemplated that various embodiments of the vacuum cell may be particularly configured for use with a Transmission Electron Microscope, a Scanning Probe Microscope that operate with quantum sensors such as Nitrogen Vacancies, Superconducting Quantum Interference Devices (SQUIDs), and other exotic sensors. It is also contemplated that the vacuum cell may be compatible with microscope operating a low temperature and high magnetic fields. The vacuum cell may also be configured for use with microscopes that operate under vacuum conditions such as a specialized Optical or other Microscope employing photons for imaging.

It is also contemplated that certain embodiments of the vacuum cell may include a first base part configured to allow optical access via electromagnetic radiation (electrons, photons) to the sample for the purpose of imaging and stimulating samples with electromagnetic excitations.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A vacuum cell configured to transport a specimen for imaging by an imaging device in prescribed vacuum conditions, the vacuum cell comprising:
a first base part including a mounting engagement portion and a sample support portion coupled to the mounting engagement portion, the mounting engagement portion being configured to be engageable with the imaging device, the sample support portion being configured to support the specimen for imaging; and
a second upper part operatively connectable to the first base part and selectively transitional relative to the first base part between an open position and a closed position, the second upper part and first base part collectively defining a sample chamber configured to retain the sample when the second upper part is in the closed position, the sample chamber being exposed to an outside environment when the second upper part is in the open position.

2. The vacuum cell recited in claim 1, wherein the second upper part includes a pressure control opening formed therein, the pressure control opening extending between the sample chamber and an ambient environment outside the vacuum cell.

3. The vacuum cell recited in claim 2, further comprising a flexible membrane extending over the pressure control opening at an outer surface of the second upper part.

4. The vacuum cell recited in claim 1, wherein the second upper part includes a chamber peripheral surface and an end surface coupled to the chamber peripheral surface, the chamber peripheral surface being configured to extend upwardly relative to the sample support portion of the first base part when the second upper part is in the closed position.

5. The vacuum cell recited in claim 1, wherein the first base part is connected to the second upper part via a spring configured to bias the second upper part toward the open position.

6. The vacuum cell recited in claim 5, wherein the first base part includes a first outer surface and a first groove formed in the first outer surface and the second upper part includes a second outer surface and a second groove formed in the second outer surface, the spring having a first connector part receivable in the first groove and a second connector part receivable in the second groove to facilitate connection with the first base part and second upper part.

7. The vacuum cell recited in claim 1, wherein the first base part is pivotally connected to the second upper part such that the second upper part transitions between the open position and the closed position via pivotal movement of the second upper part relative to the first base part.

8. The vacuum cell recited in claim 1, wherein the mount engagement portion includes a pin stub adapted for engagement with the imaging device.

9. The vacuum cell recited in claim 1, further comprising an o-ring configured to create a fluid-tight seal between the first base part and second upper part when the second upper part is in the closed position.

10. The vacuum cell recited in claim 9, wherein at least one of the first base part and the second upper part include a recess adapted to receive the o-ring.

11. A vacuum cell configured to transport a specimen in an enclosure and enable opening of the vacuum cell in-situ for imaging by an imaging device in prescribed vacuum conditions, the vacuum cell comprising:
a first base part including:
a mounting pin adapted to be received in an opening formed in the imaging device; and
a sample support surface coupled to the mounting pin, the sample support surface being configured to support the specimen for imaging; and
a second upper part operatively connectable to the first base part and having a recess formed therein, the second upper part being selectively transitional relative to the first base part between an open position and a closed position, the recess of the second upper part being moved over the sample support surface when the second upper part is in the closed position such that the second upper part and first base part collectively defining a sample chamber configured to retain the sample, the sample chamber being exposed to an outside environment when the second upper part is in the open position.

12. The vacuum cell recited in claim 11, wherein the second upper part includes a pressure control opening formed therein, the pressure control opening extending between the sample chamber and an ambient environment outside the vacuum cell.

13. The vacuum cell recited in claim 12, further comprising a flexible membrane extending over the pressure control opening at an outer surface of the second upper part.

14. The vacuum cell recited in claim 11, wherein the first base part is connected to the second upper part via a spring configured to bias the second upper part toward the open position.

15. A method of imaging a sample, the method comprising the steps of:
mounting the sample on a mounting surface of a first base part of a vacuum cell;
enclosing the sample within a sample chamber defined by the first base part and a second upper part of the vacuum cell;
creating a pressure differential between the sample chamber and an ambient environment outside the vacuum cell; and
opening the vacuum cell when the vacuum cell is aligned with an imaging device to facilitate imaging of the sample.

16. The method recited in claim 15, wherein the enclosing step includes pivoting the second upper part relative to the first base part, the second upper part being connected to the first base part via a hinge to facilitate pivotal movement between the second upper part and the first base part.

17. The method recited in claim 15, wherein the enclosing step includes placing the second upper part over the first base part.

18. The method recited in claim 17, further comprising the step of attaching a spring to the first base part and the second upper part, the spring being configured to impart a force on the second upper part to urge the second upper part away from the first base part when the second upper part is closed over the first base part.

19. The method recited in claim 18, wherein the step of attaching the spring includes inserting a first connector part of the spring in a first groove formed on the first base part, and inserting a second connector part of the spring in a second groove formed on the second upper part.

20. The method recited in claim 15, wherein the opening step includes creating a pressure differential where pressure outside of the vacuum cell is less than pressure inside sample chamber.
